(19) United States
(12) Patent Application Publication
(10) Pub. No.: US 2026/0270644 A1
(43) Pub. Date: Sep. 10, 2026

(54) Device Control Method and Device Control Apparatus

(71) Applicant: Yamaha Corporation, Hamamatsu-shi (JP)

(72) Inventors: Koki Higashihara, Hamamatsu-shi (JP); Koichiro Sato, Hamamatsu-shi (JP); Takamitsu Aoki, Hamamatsu-shi (JP)

(21) Appl. No.: 19/666,478

(22) Filed: May 4, 2026

Related U.S. Application Data
(63) Continuation of application No. PCT/JP2024/037376, filed on Oct. 21, 2024.

(30) Foreign Application Priority Data
Nov. 6, 2023 (JP) 2023-189169

(51) Int. Cl. H04S 7/00; H04R 5/02; H04R 5/027; H04R 5/04

(52) U.S. Cl. CPC H04S 7/308; H04R 5/02; H04R 5/027; H04R 5/04; H04R 2420/07

(57) ABSTRACT

A device control method includes acquiring an image of an acoustic device installed in a room; acquiring first device information from the acquired image of the acoustic device; determining that the acoustic device is wirelessly connectable based on the first device information; and instructing a wireless device to connect to the acoustic device in response to determining that the acoustic device is wirelessly connectable.

### CROSS-REFERENCE TO RELATED APPLICATIONS

This is a continuation of International Application No. PCT/JP2024/037376 filed on Oct. 21, 2024, and claims priority from Japanese Patent Application No. 2023-189169 filed on Nov. 6, 2023, the entire content of each of which is incorporated herein by reference.

### TECHNICAL FIELD

The present invention relates to a device control method for automatically connecting a peripheral device using information acquired by a camera in a wireless communication device.

### BACKGROUND

In the related art, there has been known an authentication processing technique in which when a peer-to-peer simple network is constructed and used, information giving communication permission output by a partner device is read by a digital camera.

For example, Patent Literature 1 discloses a wireless communication authentication apparatus that is mounted on a digital camera and enables wireless communication with a partner device, the partner device having an information output unit configured to output information giving communication permission and an authentication unit configured to authenticate the information, the wireless communication authentication apparatus including: an information acquiring unit configured to acquire the information output from the information output unit of the partner device; and a recognition unit configured to recognize the information acquired by the information acquiring unit.

### PATENT LITERATURE

Patent Literature 1: JP2004-178187A

### SUMMARY

However, the wireless communication authentication apparatus disclosed in Patent Literature 1 is used when the peer-to-peer simple network is constructed and used in an environment in which there is no access point, and an environment in which a plurality of partner devices to be communicated with are installed is not assumed. In addition, in the wireless communication authentication apparatus disclosed in Patent Literature 1, there is a problem that the information giving communication permission output by the partner device is limited to barcode information.

An object of the present disclosure is to provide a device control method capable of automatically connecting a partner device using information acquired by a camera regardless of the number of partner devices to be communicated with.

A method for controlling a device, the method including:
acquiring an image of an acoustic device installed in a room;
acquiring first device information from the acquired image of the acoustic device;
determining that the acoustic device is wirelessly connectable based on the first device information; and
instructing a wireless device to connect to the acoustic device in response to determining that the acoustic device is wirelessly connectable.

According to the method of the present disclosure, an effect that a partner device can be automatically connected regardless of the number of partner devices to be communicated with is achieved.

### BRIEF DESCRIPTION OF DRAWINGS

FIG. 1 is a block diagram illustrating a basic configuration of an information processing system 1;

FIG. 2 is a block diagram illustrating a basic configuration of a data processing apparatus 10;

FIG. 3 is an external perspective view of a room R1 according to a first embodiment, a second embodiment, and a third embodiment;

FIG. 4 is a flowchart illustrating an operation executed by a CPU 11 according to the first embodiment;

FIG. 5 is a flowchart illustrating an operation executed by the CPU 11 according to the second embodiment;

FIG. 6 is a flowchart illustrating an operation executed by the CPU 11 according to the third embodiment;

FIG. 7 is a plan view of a large conference room R2 according to a fourth embodiment;

FIG. 8 is a plan view of the large conference room R2 according to the fourth embodiment;

FIG. 9 is a plan view of the large conference room R2 according to the fourth embodiment; and

FIG. 10 is a block diagram illustrating a basic configuration of an information processing system 1 according to Modification 1.

### DETAILED DESCRIPTION

Hereinafter, an information processing system according to an embodiment of the present disclosure will be described with reference to the drawings. In the drawings, the same portions are denoted by the same reference numerals. In Modification 1 and subsequent modifications, descriptions of matters common to a first embodiment will be omitted, and only differences will be described. In particular, similar operations and effects of similar configurations will not be described in each embodiment.

### First Embodiment

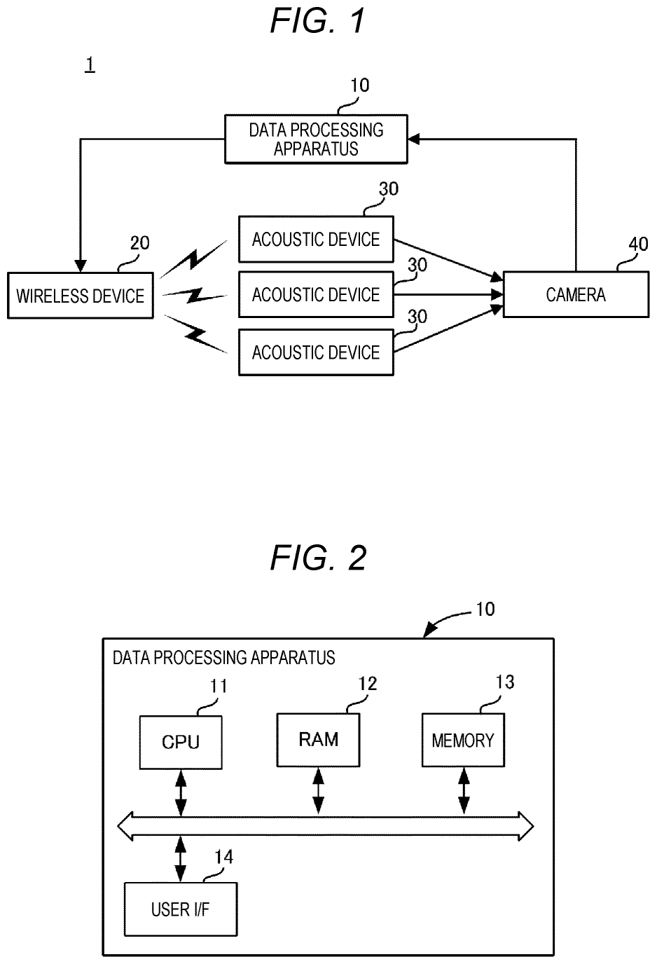

FIG. 1 is a block diagram illustrating a basic configuration of an information processing system 1. As illustrated in FIG. 1, the information processing system 1 includes a data processing apparatus 10, a wireless device 20, an acoustic device 30, and a camera 40.

The wireless device 20 is, for example, a signal processing apparatus that receives a sound signal from the acoustic device 30 and executes signal processing. Alternatively, the wireless device 20 may be a wireless access point that connects the acoustic device 30 to a network. The acoustic device 30 is a small desktop microphone. The acoustic device 30 may be a small desktop speaker, a large speaker, a personal computer with a microphone speaker built therein, a smartphone, a wearable terminal, or a device capable of recording and reproducing a sound such as music. Hereinafter, these are collectively referred to as the acoustic device 30.

The data processing apparatus 10 is connected to the wireless device 20 and the camera 40. The camera 40 captures an image of the acoustic device 30. The camera 40 transmits the captured image to the data processing apparatus 10. The data processing apparatus 10 acquires device information from the image of the acoustic device 30 captured by the camera 40. The device information is information for identifying the acoustic device 30. The device information is, for example, information related to an appearance shape of a product, and corresponds to model information.

FIG. 2 is a block diagram illustrating a basic configuration of the data processing apparatus 10. As illustrated in FIG. 2, the data processing apparatus 10 includes a CPU 11, a RAM 12, a memory 13, and a user interface (I/F) 14.

The memory 13 stores a program for causing the data processing apparatus 10 to operate. The CPU 11 reads the program stored in the memory 13 into the RAM 12 and controls an operation of the data processing apparatus 10. However, the program does not need to be stored in the memory 13. The CPU 11 may download the program from, for example, a server when needed.

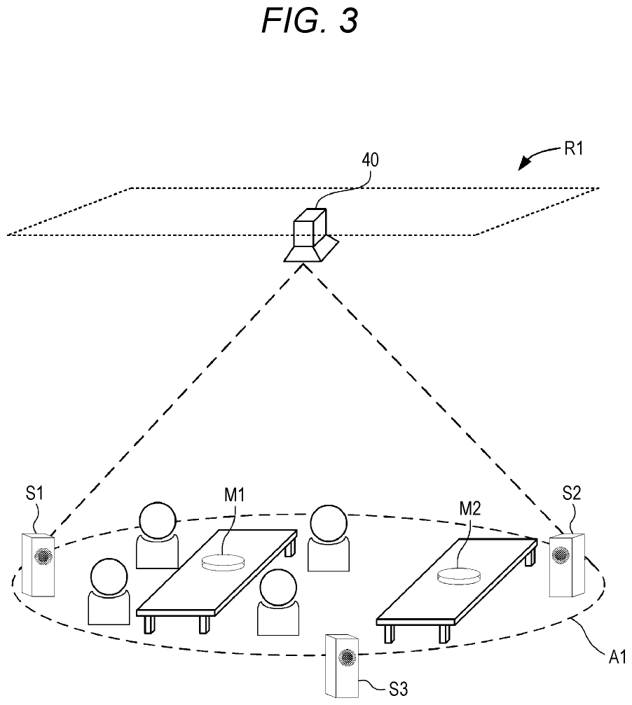

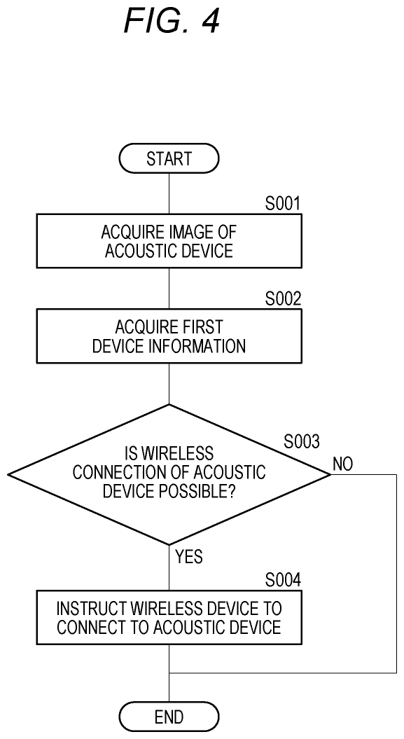

Next, a flow from when the camera 40 captures the image of the acoustic device 30 to when the data processing apparatus 10 instructs the wireless device 20 to connect to the acoustic device 30 will be described with reference to FIGS. 3 and 4.

FIG. 3 is an external perspective view of a room R1 according to the first embodiment.

In the present embodiment, the camera 40 installed in the room R1 is, for example, a ceiling camera. The camera 40 is not limited to the ceiling camera, and may be a camera installed on a wall or a camera placed in a conference monitor. The camera 40 may be installed at a position where an image of the acoustic device 30 can be captured.

In FIG. 3, an angle of view A1 of the camera 40 is indicated by a broken line. That is, the camera 40 captures an image of a range of the angle of view A1 and transmits the captured image to the data processing apparatus 10. In addition, within the angle of view A1 of the room R1, a speaker S1 and a desktop microphone M1 are installed around a user, and a speaker S2 and a desktop microphone M2 are installed at positions away from the user. A speaker S3 is installed outside the angle of view A1 of the room R1. In the present embodiment, the speakers S1 to S3 and the desktop microphones M1 and M2 are examples of the acoustic device 30 of the present disclosure.

FIG. 4 is a flowchart illustrating an operation executed by the CPU 11 according to the first embodiment. As illustrated in FIG. 4, the data processing apparatus 10 acquires the image of the acoustic device 30 captured by the camera 40 (S001). As described above, the image captured by the camera 40 includes the device information of the acoustic device 30.

Next, the data processing apparatus 10 acquires information on an appearance shape of the acoustic device 30 as “first device information” based on the image received from the camera 40 (S002).

Next, the data processing apparatus 10 determines whether wireless connection of the acoustic device 30 is possible based on the first device information (S003). The data processing apparatus 10 may store device information of a connection target (for example, information of appearance shape, information of logo, or the like) in the memory 13 in advance, and determine that the wireless connection of the acoustic device 30 is possible when the device information of the registered connection target matches the first device information. In another determination method, the data processing apparatus 10 may store the first device information of the acoustic device 30 connected in the past in the memory 13, and determine that the wireless connection of the acoustic device 30 is possible when the first device information in the past stored in the memory 13 matches newly acquired first device information. In addition, the CPU 11 may determine whether the wireless connection of the acoustic device 30 is possible by using a training model obtained by training a relation among the device information of the acoustic device 30, the image of the camera, and whether the wireless connection is possible in a predetermined model that uses a neural network or the like.

When it is determined that the wireless connection is possible (YES in S003), the data processing apparatus 10 instructs the wireless device 20 to connect to the acoustic device 30 (S004). The wireless device 20 that has received the instruction from the data processing apparatus 10 executes pairing with the acoustic device 30.

As described above, in the present embodiment, when the acoustic device 30 is installed within the angle of view A1 captured by the camera 40, the wireless device 20 and the acoustic device 30 are paired. On the other hand, when the acoustic device 30 is installed outside the angle of view A1 that is not captured by the camera 40 as the speaker S3 of FIG. 3, the wireless device 20 and the acoustic device 30 are not paired.

Accordingly, a user of the information processing system 1 can automatically complete the connection between the wireless device 20 and the acoustic device 30 without performing complicated work. That is, the user of the information processing system 1 can obtain a new customer experience that only an acoustic device 30 desired to be used can be automatically connected to the wireless device 20 only by, among a plurality of acoustic devices 30, moving only the acoustic device 30 desired to be used at that time into the angle of view A1 of the camera 40 and moving an acoustic device 30 not desired to be used outside the angle of view A1 of the camera 40.

### Second Embodiment

In the first embodiment, even an acoustic device 30 installed at a position away from the user is connected to the wireless device 20 as long as the acoustic device 30 is installed within the angle of view A1 of the camera 40. However, even for the acoustic device 30 installed within the angle of view A1 of the camera 40, when the acoustic device 30 is installed at a position away from the user, the following processing may be executed.

In an example of FIG. 3, the speaker S2 and the desktop microphone M2 are installed at positions away from the user. In this case, the data processing apparatus 10 does not issue an instruction to the wireless device 20 to connect to the speaker S2 and the desktop microphone M2. Specifically, the data processing apparatus 10 determines not to issue the instruction to the wireless device 20 to connect to the speaker S2 and the desktop microphone M2 by executing the following operation.

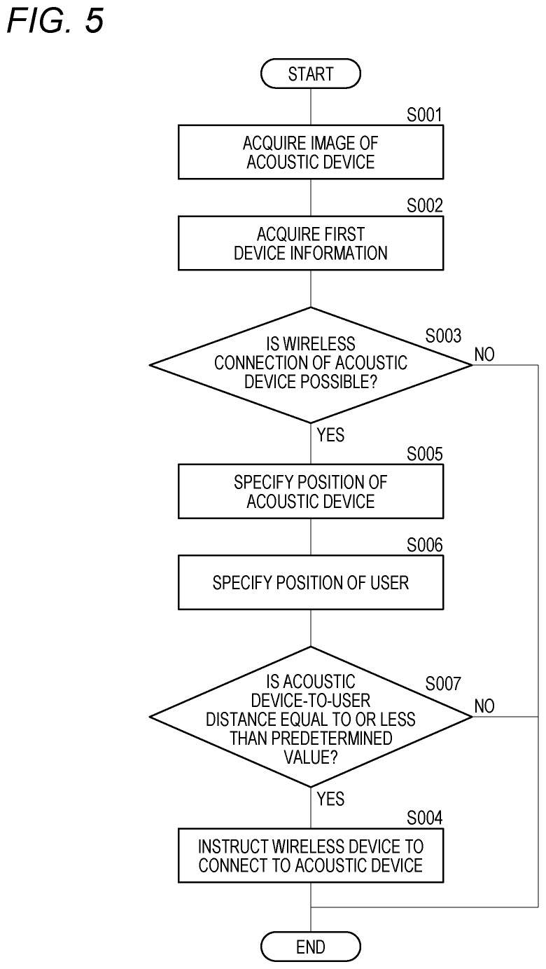

FIG. 5 is a flowchart illustrating an operation executed by the CPU 11 according to the second embodiment. Since processing of steps S001, S002, S003, and S004 in FIG. 5 is the same as processing of steps S001, S002, S003, and S004 in FIG. 4, the description thereof will be omitted. In step S003, when it is determined that the wireless connection of the acoustic device 30 is possible (YES in S003), the data processing apparatus 10 specifies a position of the acoustic device 30 (S005). When it is determined that the wireless connection is impossible (NO in S003), the data processing apparatus 10 ends the processing (END). After step S005, the data processing apparatus 10 specifies a position of the user from the received image (S006).

Position information of the acoustic device 30 and the user specified in steps S005 and S006 includes two-dimensional position information. The two-dimensional position information is an X and Y coordinate (orthogonal coordinate) with a predetermined position (for example, lower left) of the image captured by the camera 40 as an origin.

Next, the data processing apparatus 10 calculates a distance between the acoustic device 30 and the user based on the specified position information of the acoustic device 30 and the user, and determines whether the distance is equal to or less than a predetermined value (S007). When it is determined that a determination result is equal to or less than the predetermined value (YES in S007), the data processing apparatus 10 instructs the wireless device 20 to connect to the acoustic device 30 (S004). When it is determined that the determination result is larger than the predetermined value (NO in S007), the data processing apparatus 10 ends the processing (END).

As described above, in the present embodiment, even the acoustic device 30 installed within the angle of view A1 captured by the camera 40 is not connected to the wireless device 20 when installed at a position away from the user. Therefore, the user of the information processing system 1 can operate only the necessary acoustic device 30. The user can obtain a new customer experience of being able to experience an improvement in energy saving effect such as not connecting an unnecessary acoustic device without performing any particular work.

In the present embodiment, when a plurality of acoustic devices 30 are included in the image captured by the camera 40, the data processing apparatus 10 may acquire both device information of the acoustic devices 30 and detected position information of the acoustic devices 30 as the “first device information”. Accordingly, even if the data processing apparatus 10 acquires the same device information for the plurality of acoustic devices 30 in the image, since the position information of each of the plurality of acoustic devices 30 is different, each of the plurality of acoustic devices 30 can be identified. That is, even when the speaker S1 and the speaker S2, and the desktop microphone M1 and the desktop microphone M2 have the same model and the same device information, the data processing apparatus 10 does not erroneously recognize the speaker S1 and the speaker S2, and the desktop microphone M1 and the desktop microphone M2 as the same acoustic device 30.

### Third Embodiment

In the second embodiment, the positions of the acoustic device 30 and the user are specified from the image acquired by the camera 40, and only the acoustic device 30 installed at a position close to the user is connected to the wireless device 20. However, even for the acoustic device 30 installed at a position away from the user, when there is an acoustic device 30 desired to be constantly connected to the wireless device 20, the following processing may be executed.

As described above, in the room R1 illustrated in FIG. 3, the speaker S1 and the desktop microphone M1 are installed around the user, and the speaker S2 and the desktop microphone M2 are installed at positions away from the user. In such an environment, the user of the information processing system 1 may desire to keep constant connection only between the wireless device 20 and the speaker S2. For example, the user may desire to improve sound quality by outputting sounds from a larger number of speakers also using the speaker S2 at a distant position. In such a case, the user of the information processing system 1 can maintain a state in which the speaker S2 is connected to the wireless device 20 regardless of the position of the user by registering device information of the speaker S2 in the memory 13 in advance.

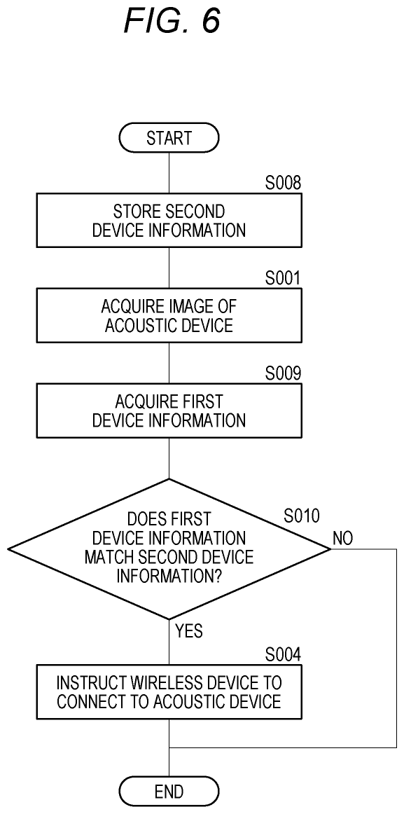

FIG. 6 is a flowchart illustrating an operation executed by the CPU 11 according to the third embodiment. Since processing of steps S001 and S004 in FIG. 6 is the same as the processing of steps S001 and S004 in FIG. 4, the description thereof will be omitted. The data processing apparatus 10 receives an input from the user of the information processing system 1 via the user I/F 14. Specifically, the user of the information processing system 1 inputs device information of the acoustic device 30 desired to be constantly connected to the wireless device 20. The user determines, for example, an ID (numerical value) unique to the acoustic device 30 desired to be constantly connected, and inputs the unique ID as the device information. In addition, the user prepares a piece of paper on which the unique ID is written, and attaches the paper to the acoustic device 30 desired to be constantly connected. The data processing apparatus 10 stores the device information input by the user of the information processing system 1 as “second device information” in the memory 13 (S008).

Next, the data processing apparatus 10 acquires the image of the acoustic device 30 from the camera 40 (S001). Next, the data processing apparatus 10 acquires the device information included in the image as the “first device information” (S009). Here, the data processing apparatus 10 also recognizes a numerical value (unique ID) or the like in addition to the appearance shape as the device information.

Next, the data processing apparatus 10 determines whether the first device information matches the second device information (S010). Here, when the data processing apparatus 10 recognizes a numerical value matching the unique ID (numerical value) input by the user, the data processing apparatus 10 determines that the first device information matches the second device information. When it is determined that the first device information matches the second device information (YES in S010), the data processing apparatus 10 instructs the wireless device 20 to connect to the acoustic device 30 (S004). When it is determined that the first device information does not match the second device information (NO in S010), the data processing apparatus 10 ends the processing (END).

As described above, in the present embodiment, even when the acoustic device 30 is installed at a position away from the user, the user of the information processing system 1 can maintain the state of being connected to the wireless device 20 by inputting the device information to the data processing apparatus 10 in advance.

### Fourth Embodiment

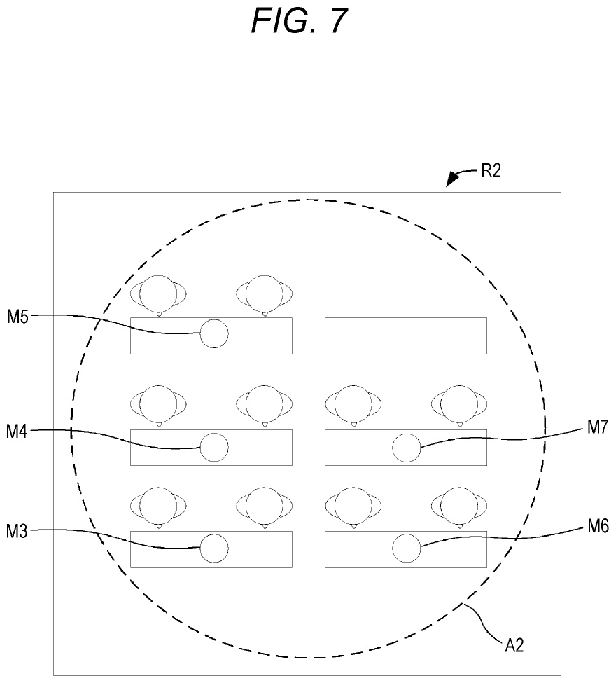

FIGS. 7, 8, and 9 are plan views of a large conference room R2 according to the fourth embodiment. Ranges indicated by broken lines in FIGS. 7, 8, and 9 indicate an angle of view A2 of the camera 40 in the present embodiment.

In the present embodiment, the number of the camera 40 installed in the large conference room R2 may be one or more. In addition, it is assumed that the angle of view A2 can be optionally set by the user of the information processing system 1. In addition, a monitor (not illustrated) that projects the image captured by the camera 40 may be installed in the large conference room R2 such that the user of the information processing system 1 can visually recognize the angle of view A2 of the camera 40.

As illustrated in FIG. 7, a plurality of desktop microphones M3 to M7 are installed near the user in the large conference room R2. In the present embodiment, the desktop microphones M3 to M7 are examples of the acoustic device 30 of the present disclosure.

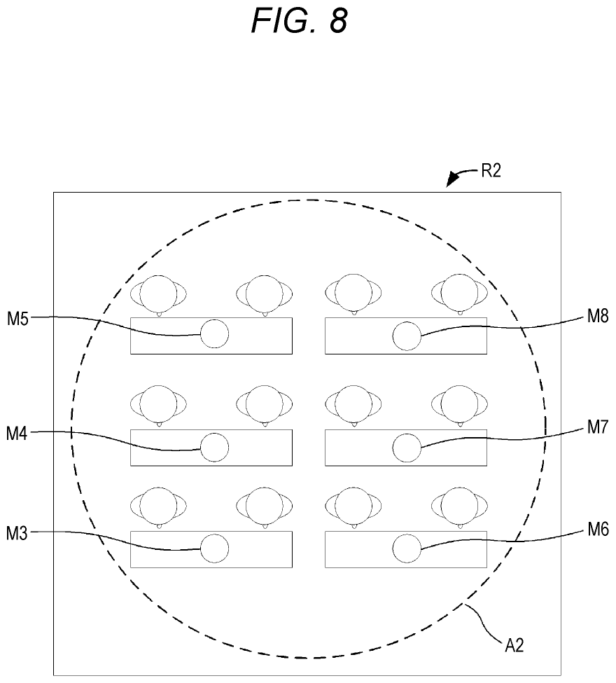

In FIG. 7, it is assumed that the data processing apparatus 10 has already completed connection between the wireless device 20 and the desktop microphones M3 to M7 based on first device information of the desktop microphones M3 to M7. In such a situation, for example, it is assumed that two new users bring a desktop microphone M8 into the large conference room R2 and change the layout to that illustrated in FIG. 8. In such a case, the data processing apparatus 10 receives a new image from the camera 40, newly acquires first device information of the desktop microphone M8 from the image, and instructs the wireless device 20 to connect to the desktop microphone M8 based on the first device information.

In the present embodiment, the data processing apparatus 10 continuously receives images from the camera 40 in real time. Accordingly, the user of the information processing system 1 can easily connect the wireless device 20 and the acoustic device 30 at any time by moving the acoustic device 30 desired to be connected to the wireless device 20 into the angle of view A2 of the camera 40.

The user of the information processing system 1 may desire to return from the layout of FIG. 8 to the layout of FIG. 7. In such a case, the user may move the desktop microphone M8 outside the angle of view A2 of the camera 40. At the time when the first device information of the desktop microphone M8 cannot be acquired from the image received from the camera 40, the data processing apparatus 10 instructs the wireless device 20 to release the connection with the desktop microphone M8.

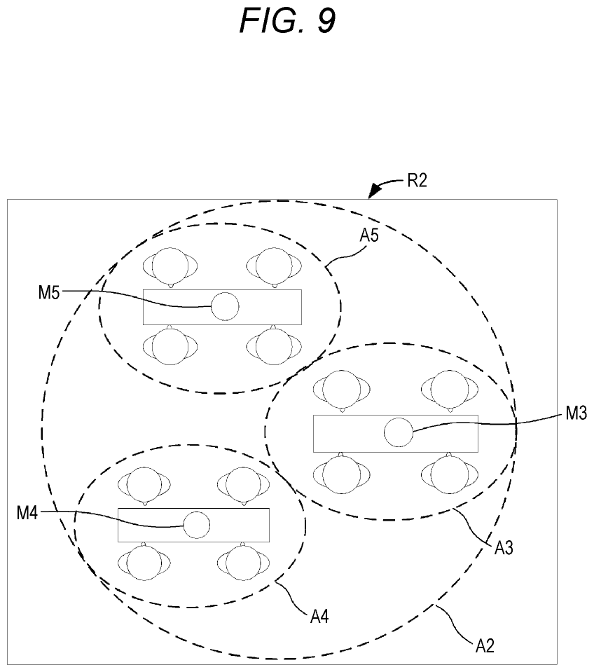

The user of the information processing system 1 may desire to change a layout of a lecture form illustrated in FIG. 8 to a layout of a discussion form illustrated in FIG. 9. In such a case, the user of the information processing system 1 sets a plurality of regions (angles of view A3, A4, and A5) from the image of the camera 40. The data processing apparatus 10 receives the image from the camera 40 and acquires first device information of the desktop microphones M3 to M5 from the angles of view A3, A4, and A5 in the image, respectively. The data processing apparatus 10 instructs the wireless device 20 to connect to the desktop microphones M3 to M5 based on the acquired first device information from the angles of view A3, A4, and A5, respectively. In this case, the data processing apparatus 10 instructs three different wireless devices 20 to connect to the desktop microphones M3 to M5, respectively.

As described above, in the present embodiment, the user of the information processing system 1 can easily create a space such as a small conference room by further setting the angles of view A3, A4, and A5 of small spaces from the angle of view A2 of the camera 40 without changing the room.

### Modification 1

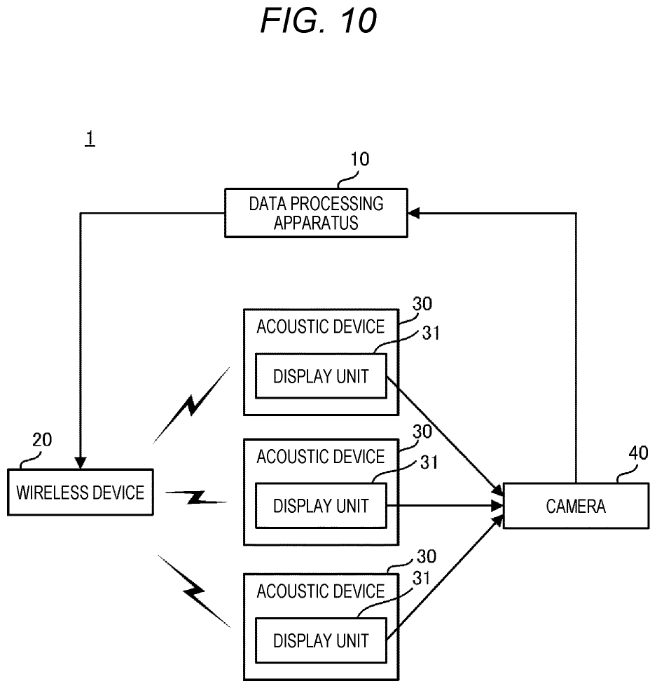

FIG. 10 is a block diagram illustrating a basic configuration of an information processing system 1 according to Modification 1.

In Modification 1, the acoustic device 30 further includes a display unit 31 and displays the device information of the acoustic device 30 on the display unit 31. Examples of the device information displayed on the display unit 31 include a two-dimensional code, a manufacturer logo, a product logo, an LED lighting pattern, and a barcode, in addition to the information related to the appearance shape.

When the two-dimensional code is used as the device information, the two-dimensional code includes only information for identifying the acoustic device 30. The data processing apparatus 10 reads only the two-dimensional code related to the device information, and does not read other two-dimensional codes. For example, even in a case where a confidential document on which a two-dimensional code for accessing confidential information in a company is printed is placed beside the acoustic device 30, the camera 40 does not read the two-dimensional code of the confidential document, and there is no risk of leading to leakage of the confidential information.

Finally, the description of the present embodiment should be considered to be illustrative in all respects and not restrictive. The scope of the present invention is indicated by the claims rather than the embodiments described above. Further, the scope of the present invention is intended to include all modifications within a meaning and a scope equivalent to the claims.

What is claimed is:

1. A method for controlling a device, the method comprising:
acquiring an image of an acoustic device installed in a room;
acquiring first device information from the acquired image of the acoustic device;
determining that the acoustic device is wirelessly connectable based on the first device information; and
instructing a wireless device to connect to the acoustic device in response to determining that the acoustic device is wirelessly connectable.

2. The method according to claim 1,
wherein the first device information includes information related to a shape, a logo, a two-dimensional code, or an LED lighting pattern of the acoustic device.

3. The method according to claim 1,
wherein the image includes an image of a plurality of the acoustic devices,
wherein the first device information includes position information of each of the plurality of acoustic devices, and
wherein each of the plurality of acoustic devices is identified based on the position information.

4. The method according to claim 1, further comprising:
storing second device information in a storage unit in advance; and
determining that the acoustic device is wirelessly connectable in response to the first device information matching the second device information.

5. The method according to claim 4,
wherein the second device information includes a shape, a logo, a two-dimensional code, or an LED lighting pattern of the acoustic device.

6. The method according to claim 1, further comprising:
instructing the wireless device to release connection with the acoustic device in response to the first device information of the acoustic device not being acquirable from the image.

7. The method according to claim 1,
wherein the wireless device comprises a signal processing apparatus that receives a sound signal from the acoustic device and executes signal processing, or a wireless access point that connects the acoustic device to a network.

8. A device control apparatus comprising:
a camera configured to acquire an image of an acoustic device installed in a room;
a processor configured to acquire first device information from the acquired image of the acoustic device and determine that the acoustic device is wirelessly connectable based on the first device information; and
a wireless device wirelessly connected to the acoustic device, wherein
the processor is configured to instruct the wireless device to connect to the acoustic device in response to determining that the acoustic device is wirelessly connectable.

9. The device control apparatus according to claim 8,
wherein the processor is configured to acquire a shape, a logo, a two-dimensional code, or an LED lighting pattern of the acoustic device as the first device information.

10. The device control apparatus according to claim 8,
wherein the camera is configured to acquire an image including a plurality of the acoustic devices, and
wherein the processor is configured to acquire the first device information including position information of each of the plurality of acoustic devices, and identify each of the plurality of acoustic devices based on the position information.

11. The device control apparatus according to claim 8,
wherein the processor is configured to store second device information in a storage unit in advance, and
wherein the processor is configured to determine that the acoustic device is wirelessly connectable in response to the first device information matching the second device information.

12. The device control apparatus according to claim 11,
wherein the processor is configured to acquire a shape, a logo, a two-dimensional code, or an LED lighting pattern of the acoustic device as the second device information.

13. The device control apparatus according to claim 8,
wherein the processor is configured to instruct the wireless device to release connection with the acoustic device in response to the first device information of the acoustic device not being acquirable from the image.

14. The device control apparatus according to claim 8,
wherein the wireless device comprises a signal processing apparatus that is configured to receive a sound signal from the acoustic device and execute signal processing, or a wireless access point that is configured to connect the acoustic device to a network.
